(19) United States
(12) Patent Application Publication
(10) Pub. No.: US 2024/0235264 A1
(43) Pub. Date: Jul. 11, 2024

(54) WIRELESS POWER SUPPLY SYSTEM, POWER TRANSMITTER, POWER RECEIVER, AND WIRELESS POWER SUPPLY SYSTEM CONTROL METHOD

(71) Applicant: SHARP KABUSHIKI KAISHA, Sakai City, Osaka (JP)

(72) Inventor: HIROKAZU KOBAYASHI, Sakai City, Osaka (JP)

(21) Appl. No.: 18/572,376

(22) PCT Filed: Feb. 16, 2022
(86) PCT No.: PCT/JP2022/006029

§ 371 Date: Dec. 20, 2023

(30) Foreign Application Priority Data
Jun. 28, 2021 (JP) 2021-106310

(51) Int. Cl. H02J 50/10; H02J 50/80; H02J 50/90

(52) U.S. Cl. CPC H02J 50/10; H02J 50/80; H02J 50/90

(57) ABSTRACT

A wireless power supply system includes a plurality of power transmitters including a master power transmitter and slave power transmitters controlled by the master power transmitter, and a power receiver to which power is supplied by a radio waves transmitted from each of the plurality of power transmitters. A first power transmitter of the plurality of power transmitters includes a determination unit configured to determine a power transmitter serving as the master power transmitter, based on a signal received from the power receiver or each of other power transmitters of the plurality of power transmitters.

### TECHNICAL FIELD

The present invention relates to a wireless power supply system, a power transmitter, a power receiver, and a method of controlling a wireless power supply system. This application claims priority based on JP 2021-106310 filed on Jun. 28, 2021, the contents of which are incorporated herein by reference.

### BACKGROUND ART

PTL 1 discloses a wireless power supply method of wirelessly transmitting power to a power receiver through electromagnetic waves.

In the wireless power supply method disclosed in PTL 1, in a wireless power supply system including a plurality of power transmission units including a master power transmission unit and slave power transmission units, power is transmitted from the plurality of power transmission units to one power receiver.

### CITATION LIST

### Patent Literature

PTL 1: JP 6501838 B

### SUMMARY OF INVENTION

### Technical Problem

However, in PTL 1 described above, the power transmission unit serving as the master power transmission unit is fixed, and thus power cannot be efficiently supplied to the power receiver in a case that the power receiver cannot be detected by the master power transmission unit.

An object of the present disclosure is to provide a wireless power supply system capable of appropriately supplying power to a power receiver, a power transmitter, a power receiver, and a method of controlling a wireless power supply system.

### Solution to Problem

A wireless power supply system according to an aspect of the present disclosure includes: a plurality of power transmitters including a master power transmitter and slave power transmitters controlled by the master power transmitter; and a power receiver to which power is supplied by a radio wave transmitted from each of the plurality of power transmitters. A first power transmitter of the plurality of power transmitters includes a determination unit configured to determine a power transmitter serving as the master power transmitter based on a signal received from the power receiver or each of the other power transmitters of the plurality of power transmitters.

A power transmitter according to an aspect of the present disclosure is a power transmitter included in a wireless power supply system in which power is supplied to a power receiver by radio waves transmitted from a plurality of power transmitters including a master power transmitter and slave power transmitters controlled by the master power transmitter. The power transmitter includes a determination unit configured to determine a power transmitter serving as the master power transmitter based on a signal received from the power receiver or the other power transmitters of the plurality of power transmitters.

A power receiver according to an aspect of the present disclosure is a power receiver included in a wireless power supply system in which power is supplied to the power receiver by radio waves transmitted from a plurality of power transmitters including a master power transmitter and slave power transmitters controlled by the master power transmitter. The power receiver includes: a decision unit configured to decide, to be the master power transmitter, a power transmitter serving as a transmission source of a radio wave having the highest intensity among radio waves received from the plurality of power transmitters; and a power receiver-side signal transmitter configured to transmit a master decision signal including information on the master power transmitter decided by the decision unit, to each of the plurality of power transmitters.

A method of controlling a wireless power supply system according to an aspect of the present disclosure is a method of controlling a wireless power supply system including a plurality of power transmitters including a master power transmitter and slave power transmitters controlled by the master power transmitter and a power receiver to which power is supplied by radio waves transmitted from the plurality of power transmitters. The method includes determining, by a first power transmitter of the plurality of power transmitters, a power transmitter serving as the master power transmitter based on a signal received from the power receiver or each of the other power transmitters of the plurality of power transmitters.

### BRIEF DESCRIPTION OF DRAWINGS

FIG. 1 is a perspective view illustrating a schematic configuration of a wireless power supply system according to an embodiment of the present disclosure.

FIG. 2 is a block diagram illustrating a schematic configuration of the wireless power supply system according to the embodiment of the present disclosure.

FIG. 3 is a flowchart illustrating an example of a power supply operation of a power transmitter in the wireless power supply system according to the embodiment of the present disclosure.

FIG. 4 is a flowchart illustrating an example of operation processing of a master power transmitter according to an embodiment of the present disclosure.

FIG. 5 is a flowchart illustrating an example of operation processing of a slave power transmitter according to an embodiment of the present disclosure.

FIG. 6 is a flowchart illustrating an example of operation processing of a power receiver according to an embodiment of the present disclosure.

FIG. 7 is a block diagram illustrating a schematic configuration of a wireless power supply system according to a modification of an embodiment of the present disclosure.

FIG. 8 is a flowchart illustrating an example of a power supply operation of a power transmitter in a wireless power supply system according to the modification of the embodiment of the present disclosure.

FIG. 9 is a flowchart illustrating an example of operation processing of a master power transmitter according to a modification of an embodiment of the present disclosure.

FIG. 10 is a flowchart illustrating an example of operation processing of a slave power transmitter according to a modification of an embodiment of the present disclosure.

FIG. 11 is a flowchart illustrating an example of operation processing of a power receiver according to a modification of an embodiment of the present disclosure.

### DESCRIPTION OF EMBODIMENTS

Hereinafter, an embodiment and a modification of the present disclosure will be described with reference to the drawings. In the following description, the same or corresponding elements will be denoted by the same reference numerals throughout the drawings, and redundant description thereof will be omitted. The embodiment and the modification described below are merely examples of the present disclosure, and the present disclosure is not limited to the embodiment and the modification. Various changes other than the embodiment and the modification can be made in accordance with design or the like without departing from the technical idea of the present disclosure.

### Embodiment

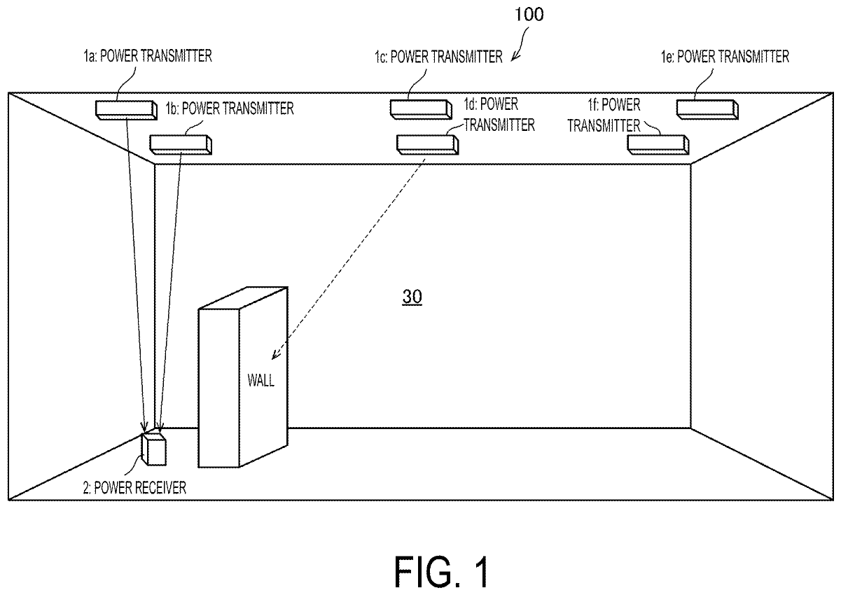

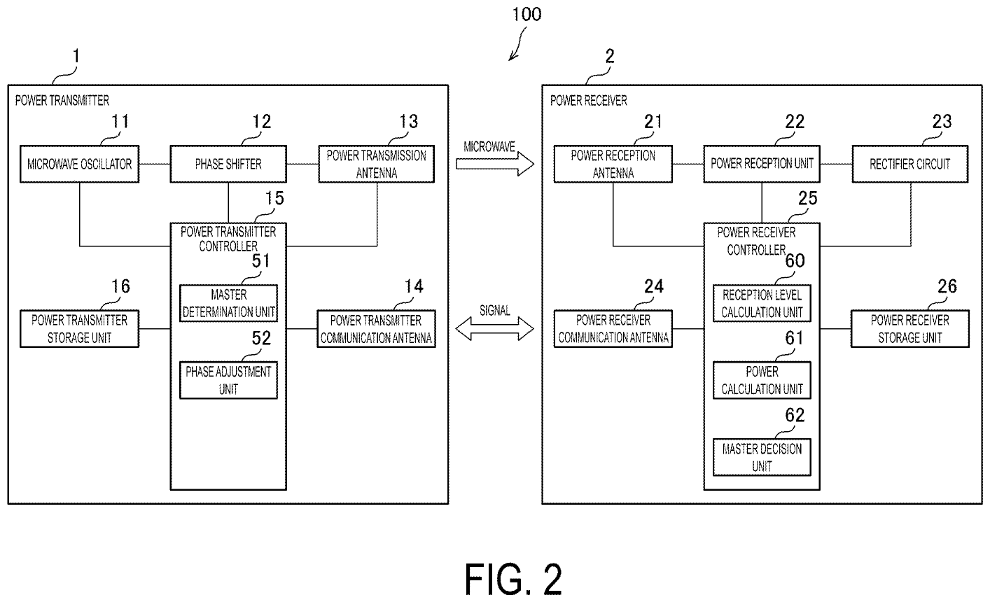

A wireless power supply system 100 according to an embodiment will be described with reference to FIGS. 1 and 2. FIG. 1 is a perspective view illustrating a schematic configuration of the wireless power supply system 100 according to the embodiment of the present disclosure. FIG. 2 is a block diagram illustrating a schematic configuration of the wireless power supply system 100 according to the embodiment of the present disclosure. In FIG. 2, for convenience of description, the configuration of the wireless power supply system 100 is illustrated by taking a relationship between one power transmitter 1 and one power receiver 2 as an example.

The wireless power supply system 100 according to the embodiment is a system in which power is supplied to the power receiver 2 by microwaves (radio waves) radiated from a plurality of power transmitters 1a to 1f in a power supply area 30. The wireless power supply system 100 includes the plurality of power transmitters 1a to 1f and the power receiver 2 provided in the power supply area 30. In a case that it is not necessary to particularly distinguish the plurality of power transmitters 1a to 1f from each other for description, the power transmitters 1a to 1f may be simply referred to as the power transmitter 1. The plurality of power transmitters 1a to 1f include a power transmitter that functions as a master power transmitter and power transmitters that function as slave power transmitters controlled by the master power transmitter. Hereinafter, for convenience of description, the master power transmitter may be referred to as a power transmitter 1a (first power transmitter), and the slave power transmitters may be referred to as power transmitters 1b to 1f (other power transmitters).

Examples of the power receiver 2 to which power is supplied include a mobile communication apparatus and a mobile robot in a factory.

As illustrated in FIG. 1, the plurality of power transmitters 1a to 1f is provided on, for example, a ceiling of the power supply area 30 not to obstruct movement of the power receiver 2 and not to obstruct communication with the power receiver 2 as much as possible. Then, power is supplied to the power receiver 2 by a microwave radiated from each of the plurality of power transmitters 1a to 1f.

The plurality of power transmitters 1a to 1f is communicably connected to each other. In the embodiment of the present disclosure, transmission and/or reception of signals between the power transmitters 1a to 1f are performed wirelessly, but the present disclosure is not limited thereto. For example, the plurality of power transmitters 1a to 1f may be connected to each other via a communication cable, and signals may be transmitted and/or received via the communication cable.

In a case that any power transmitter 1 of the plurality of power transmitters 1a to 1f detects the power receiver 2, the power transmitter 1 transmits a signal including information on the power receiver 2 serving as a transmission destination of microwaves to the other power transmitters. The information on the power receiver 2 includes information indicating that the power receiver 2 has been detected and information indicating a position of the power receiver 2. In a case that arrangement positions of the power transmitters 1a to 1f are determined in advance, the position of the power receiver 2 may be information indicating the arrangement position of the power transmitter 1 that has detected the power receiver 2. Alternatively, in a case that the power transmitter 1 has a positioning system such as Global Positioning System (GPS), a measurement result of the positioning system may be used. The power transmitter 1 that has detected the power receiver 2 may be configured to further specify the position of the power receiver 2 using a technique such as beamforming.

As illustrated in FIG. 1, transmission of a microwave from a power transmitter 1 to the power receiver 2 may be obstructed by an obstacle such as a wall in the power supply area 30. In a case that the power transmitter 1 in which transmission of a microwave to the power receiver 2 is obstructed is the master power transmitter, it is difficult to efficiently supply power to the power receiver 2 by controlling the slave power transmitters. Thus, the wireless power supply system 100 is configured to appropriately decide the master power transmitter from among the plurality of power transmitters 1a to 1f and supply power to the power receiver 2. Hereinafter, a configuration of the wireless power supply system 100 will be described.

### Configuration of Power Transmitter

A configuration of the power transmitter 1 will be first described. As illustrated in FIG. 2, the power transmitter 1 includes a microwave oscillator 11, a phase shifter 12, a power transmission antenna 13, a power transmitter communication antenna 14, a power transmitter controller 15, and a power transmitter storage unit 16.

The microwave oscillator 11 generates a microwave to be transmitted to the power receiver 2 based on a control instruction from the power transmitter controller 15. The phase shifter 12 changes a phase of the microwave generated by the microwave oscillator 11 based on the control instruction from the power transmitter controller 15. Then, the microwave with the changed phase is transmitted to the power receiver 2 via the power transmission antenna 13.

Although not particularly illustrated in FIG. 2, the power transmission antenna 13 includes a plurality of antenna elements, and the phase shifter 12 is provided for each antenna element. In addition, the power transmission antenna 13 is configured to change its orientation in accordance with the control instruction from the power transmitter controller 15.

The power transmitter communication antenna 14 (power transmitter-side signal receiver, power transmitter-side signal transmitter) is an antenna for transmitting and/or receiving a signal to and/or from the power receiver 2 or the other power transmitters. More specifically, the power transmitter 1 is configured to establish communication with the power receiver 2 and to transmit and/or receive a signal. The power transmitter 1 (for example, the power transmitter 1a) is also configured to establish communication with the other power transmitters (for example, the power transmitters 1b to 1f) provided in the power supply area 30 and to transmit and/or receive a signal.

The power transmitter controller 15 is an arithmetic processing apparatus (for example, a CPU) that performs various processes in the power transmitter 1. The power transmitter controller 15 includes a master determination unit 51 (determination unit) and a phase adjustment unit 52. These units included in the power transmitter controller 15 can be implemented by, for example, the CPU reading a program stored in the power transmitter storage unit 16 into a memory (not illustrated) and executing the program.

Although details will be described below, the signal received by the power transmitter 1 from the power receiver 2 includes a reception intensity signal indicating a reception intensity of a microwave received by the power receiver 2 and a master decision signal including an identification number of a power transmitter serving as the master power transmitter.

The master determination unit 51 determines whether the power transmitter 1 is a master power transmitter based on the master decision signal received from the power receiver 2. That is, the master determination unit 51 confirms whether the identification number of the power transmitter serving as the master power transmitter matches the identification number assigned in advance in the power transmitter 1 in the master decision signal received from the power receiver 2. In a case that the identification number of the power transmitter serving as the master power transmitter matches the identification number assigned to the power transmitter 1, the master determination unit 51 determines that the power transmitter 1 is the master power transmitter. Conversely, in a case that the identification number of the power transmitter serving as the master power transmitter does not match the identification number assigned to the power transmitter 1, the master determination unit 51 determines that the power transmitter 1 is a slave power transmitter.

In a case that the master determination unit 51 determines that the power transmitter 1 is the master power transmitter, the power transmitter 1 operates as the master power transmitter. In a case that the master determination unit 51 determines that the power transmitter 1 is a slave power transmitter, the power transmitter 1 operates as the slave power transmitter. Operations of the master power transmitter and the slave power transmitter will be described below.

The phase adjustment unit 52 controls the phase shifter 12 to adjust the phase of the microwave to be transmitted to the power receiver 2. In a case that the master determination unit 51 determines that the power transmitter 1 is the master power transmitter, the phase adjustment unit 52 calculates a phase of the microwave having the highest reception intensity in the power receiver 2 based on the reception intensity signal received from the power receiver 2. Then, the phase adjustment unit 52 controls the phase shifter 12 to change the phase of the microwave to be transmitted to the power receiver 2 to the calculated phase. The phase adjustment unit 52 transmits a synchronization signal for synchronizing a phase of a microwave transmitted from each of the other power transmitters with the calculated phase to the other power transmitters via the power transmitter communication antenna 14. As a result, the phase of the microwave transmitted from the power transmitter 1 to the power receiver 2 and the phase of the microwave transmitted from each of the other power transmitters to the power receiver 2 can be matched.

The power transmitter storage unit 16 stores various kinds of information necessary for transmitting the microwave to the power receiver 2 to supply power to the power receiver 2 and various kinds of information necessary for establishing communication with the other power transmitters. An identification number assigned to the power transmitter 1 is also stored.

### Configuration of Power Receiver

As illustrated in FIG. 2, the power receiver 2 includes a power reception antenna 21, a power reception unit 22, a rectification circuit 23, a power receiver communication antenna 24 (power receiver-side signal transmitter), a power receiver controller 25, and a power receiver storage unit 26.

In the power receiver 2, the power reception unit 22 receives the microwave transmitted from the power transmitter 1 via the power reception antenna 21. Although not particularly illustrated in FIG. 2, the power reception antenna 21 includes a plurality of antenna elements.

The rectification circuit 23 converts an energy of the microwave received by the power reception unit 22 into a direct current. The power receiver 2 supplies the converted direct current to a rechargeable battery (not illustrated) to charge the rechargeable battery. Alternatively, the power receiver 2 may be configured to supply the converted direct current to a power supply unit (not illustrated).

The power receiver communication antenna 24 is an antenna for transmitting and/or receiving a signal to and/or from each of the plurality of power transmitters 1a to 1f. The power receiver 2 is configured to establish communication with each of the plurality of power transmitters 1a to 1f to transmit and/or receive a signal.

The power receiver controller 25 is an arithmetic processing apparatus (for example, a CPU) that performs various processes in the power receiver 2. The power receiver controller 25 includes a reception level calculation unit 60, a power calculation unit 61, and a master decision unit 62 (decision unit). These units included in the power receiver controller 25 can be implemented by, for example, the CPU reading a program stored in the power receiver storage unit 26 into a memory (not illustrated) and executing the program.

The reception level calculation unit 60 calculates a reception intensity indicating a magnitude of the energy of the microwave transmitted from the power transmitter 1. The reception level calculation unit 60 performs control in such a manner that a reception intensity signal indicating the reception intensity is transmitted to the power transmitter 1 serving as a transmission source of the microwave via the power receiver communication antenna 24.

The power calculation unit 61 calculates an amount of power obtained by power supply by the power transmitters 1a to 1f. That is, the power calculation unit 61 calculates the amount of power obtained by receiving the microwaves transmitted from the power transmitters 1a to 1f based on the energy of the microwaves received by the power reception unit 22. The power calculation unit 61 determines whether the rechargeable battery has been fully charged based on the calculated amount of power. In a case that it is determined that the rechargeable battery has been fully charged, the power calculation unit 61 performs control in such a manner that a full-charge notification signal indicating the determination result is transmitted to the power transmitter 1 serving as the master power transmitter via the power receiver communication antenna 24.

The power calculation unit 61 is not limited to the configuration in which the amount of power is calculated based on the energy of the microwaves received by the power reception unit. For example, the power calculation unit 61 may be configured to calculate the amount of power from the direct current value converted by the rectification circuit 23.

The master decision unit 62 decides which of the power transmitters 1a to 1f is set as the master power transmitter based on the reception intensity of the microwave received from each of the power transmitters 1a to 1f. The master decision unit 62 decides, to be the master power transmitter, the power transmitter 1 that has transmitted the microwave having the highest reception intensity of the microwaves received from the power transmitters 1a to 1f during a predetermined period.

In the power receiver 2, in a case that the master decision unit 62 decides the master power transmitter, a master decision signal including the identification number of the power transmitter 1 decided to be the master power transmitter is transmitted to each of the plurality of power transmitters 1a to 1f. The power transmitter 1 can determine whether the power transmitter 1 itself is the master power transmitter or the slave power transmitter by receiving the master decision signal.

As described above, the power receiver 2 is configured to transmit the reception intensity signal indicating the reception intensity of the microwave received by the power reception unit 22 to the power transmitter 1. Thus, the power transmitter 1 decided to be the master power transmitter can calculate the phase of the microwave having the highest energy of the microwaves received by the power receiver 2 based on the reception intensity signal received from the power receiver 2.

As described above, the power receiver 2 is configured to transmit a full-charge notification signal indicating a determination result indicating that full charge has been achieved by the power calculation unit 61 to the power transmitter 1 serving as the master power transmitter. This allows the power transmitter 1 decided to be the master power transmitter to recognize that the rechargeable battery of the power receiver 2 has been fully charged based on the full-charge notification signal received from the power receiver 2.

The power receiver storage unit 26 stores various kinds of information necessary for supplying power by the microwaves received from the power transmitters 1a to 1f and various kinds of information necessary for establishing communication with each of the power transmitters 1a to 1f. The power receiver storage unit 26 also stores identification numbers for identifying the power transmitters 1a to 1f to distinguish the power transmitters 1a to 1f from each other.

### Power Supply Method

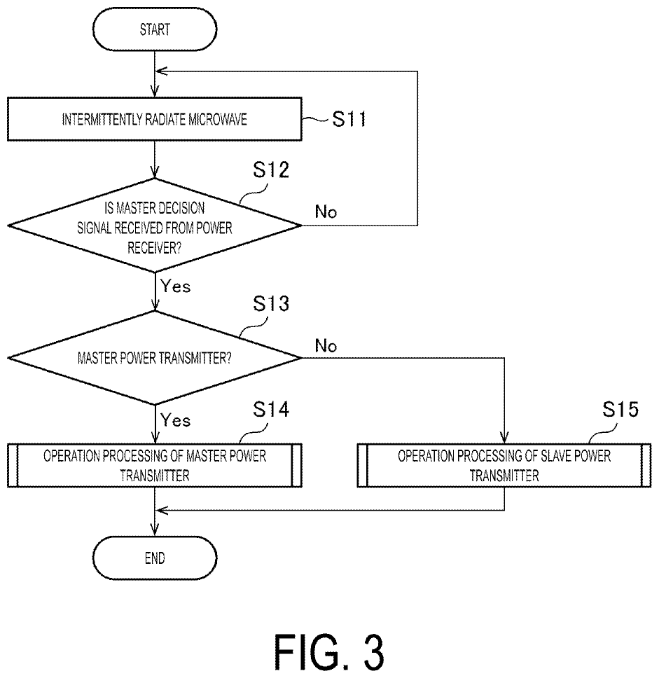

Now, a power supply method by the wireless power supply system 100 according to the embodiment will be described with reference to FIG. 3. FIG. 3 is a flowchart illustrating an example of a power supply operation of the power transmitter 1 in the wireless power supply system 100 according to the embodiment of the present disclosure.

As illustrated in FIG. 3, first, microwaves are intermittently radiated from the respective power transmitters 1a to 1f provided in the power supply area 30 (step S11). In a case that any one of the power transmitters 1a to 1f detects the power receiver 2, the power transmitter transmits a signal including information on the power receiver 2 serving as a transmission destination of the microwaves to the other power transmitters. This allows each of the power transmitters 1a to 1f to transmit a microwave toward the power receiver 2.

In a case that the power receiver 2 receives the microwaves transmitted from the power transmitters 1a to 1f, the power receiver 2 decides, to be the master power transmitter, the power transmitter 1 that is the transmission source of the microwave having the highest reception intensity of the received microwaves. Then, a master decision signal including the identification number of the power transmitter 1 decided to be the master power transmitter is transmitted to each of the power transmitters 1a to 1f.

In the power transmitter 1, the power transmitter controller 15 determines whether the master decision signal has been received from the power receiver 2 through the power transmitter communication antenna 14 (step S12).

In a case that it is determined that the master decision signal has been received from the power receiver 2 (“YES” in step S12), the master determination unit 51 determines whether the power transmitter 1 is the master power transmitter based on the received master decision signal (step S13). On the other hand, while the master decision signal is not received from the power receiver 2 (“NO” in step S12), the power transmitter 1 returns to step S11 and continues intermittent power transmission.

In a case that the master determination unit 51 determines that the power transmitter 1 is the master power transmitter (“YES” in step S13), the power transmitter 1 operates as the master power transmitter (step S14). On the other hand, in a case that the master determination unit 51 determines in step S13 that the power transmitter 1 is not the master power transmitter (“NO” in step S13), the power transmitter 1 operates as a slave power transmitter (step S15).

### Operation Processing of Master Power Transmitter

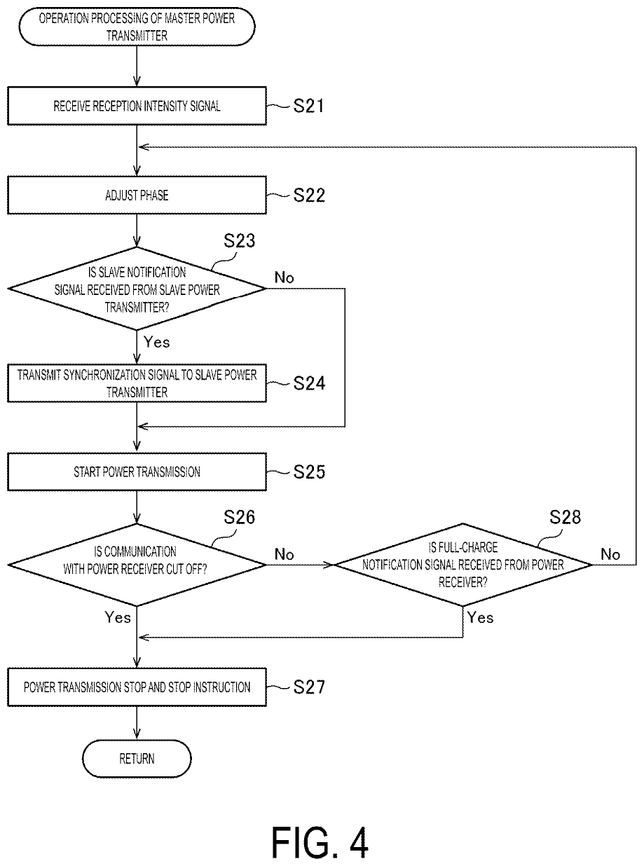

Now, operation processing of the master power transmitter will be described with reference to FIG. 4. FIG. 4 is a flowchart illustrating an example of operation processing of the master power transmitter according to the embodiment of the present disclosure.

As described above, the power transmitter 1 is configured to receive the reception intensity signal indicating the reception intensity of the microwave from the power receiver 2.

Thus, in a case that the master power transmitter (power transmitter 1a) receives the reception intensity signal from the power receiver 2 via the power transmitter communication antenna 14 (step S21), the phase adjustment unit 52 controls the phase shifter 12 to adjust the phase of the microwave to be transmitted to the power receiver 2 in such a manner that the reception intensity is maximized (step S22).

In the master power transmitter (power transmitter 1a), the power transmitter controller 15 determines whether a slave notification signal (notification signal) has been received from each of the slave power transmitters (power transmitters 1b to 1f) (step S23). The slave notification signal includes information on the power receiver 2 to which each of the slave power transmitters transmits the microwave. The master power transmitter can transmit the microwave to the power receiver 2 and recognize a slave transmitter with which communication is possible by receiving the slave notification signal from each of the slave power transmitters.

In a case that the power transmitter controller 15 determines that the slave notification signal has been received from each of the slave power transmitters (“YES” in step S23), the power transmitter controller 15 transmits a synchronization signal to each of the slave power transmitters to match the phases of the microwaves transmitted to the power receiver 2 (step S24).

Next, the master power transmitter continuously transmits a microwave with the adjusted phase toward the power receiver 2. In this way, the master power transmitter starts power transmission to the power receiver 2 (step S25).

On the other hand, in a case that the power transmitter controller 15 determines that the slave notification signal has not been received from each of the slave power transmitters (“NO” in step S23), the processing skips step S24 and proceeds to step S25. That is, the case of “NO” in step S23 is a state in which only the master power transmitter can transmit a microwave to the power receiver 2. Thus, the master power transmitter proceeds to step S25 without transmitting the synchronization signal to the slave power transmitters in step S24.

While a microwave is being transmitted from the master power transmitter to the power receiver 2, in the master power transmitter, the power transmitter controller 15 determines whether communication with the power receiver 2 has been cut off (step S26). Here, examples of the case that the communication with the power receiver 2 is cut off include a case that the power receiver 2 moves out of the power supply area 30. In a case that the power transmitter controller 15 determines that the communication with the power receiver 2 is cut off (“YES” in step S26), the master power transmitter stops power transmission to the power receiver 2. Furthermore, the master power transmitter transmits, to each of the slave power transmitters, a signal providing instruction to stop power transmission to the power receiver 2 (step S27). In a case that each of the slave power transmitters receives, from the master power transmitter, the signal providing instruction on the stop of power transmission to the power receiver 2, each of the slave power transmitters stops the transmission of the microwave to the power receiver 2.

On the other hand, in a case that the power transmitter controller 15 determines that communication with the power receiver 2 is not cut off in the master power transmitter (“NO” in step S26), the power transmitter controller 15 determines whether a full-charge notification signal has been received from the power receiver 2 (step S28). In a case that the power transmitter controller 15 determines that the full-charge notification signal has been received from the power receiver 2 (“YES” in step S28), the processing proceeds to step S27. On the other hand, in a case that the power transmitter controller 15 determines that the full-charge notification signal has not been received from the power receiver 2 (“NO” in step S28), the processing returns to step S22 and the phases of the microwaves to be transmitted to the power receiver 2 are adjusted. That is, in a case that the power receiver 2 moves in the power supply area 30, it is necessary to readjust the phases of the microwaves transmitted from the power transmitters 1a to 1f to the power receiver 2. Then, the master power transmitter returns to step S22 and adjusts the phases of the microwaves.

Note that in the case of “NO” in step S28, the step to which the processing proceeds next is not limited to step S22 described above. For example, in a case of a configuration in which once a master power transmitter is selected from the power transmitters 1a to 1f and a phase of a microwave to be transmitted from the master power transmitter to the power receiver 2 is configured, this configuration is maintained until communication between the master power transmitter and the power receiver 2 is cut off, the wireless power supply system 100 may return to step S28 and perform the processing in a case of “NO” in step S26.

In a case that the wireless power supply system 100 is configured to always decide the optimum master power transmitter from among the power transmitters 1a to 1f during power supply to the power receiver 2, the processing may return to step S13 illustrated in FIG. 3 in a case of “NO” in step S28.

### Operation Processing of Slave Power Transmitter

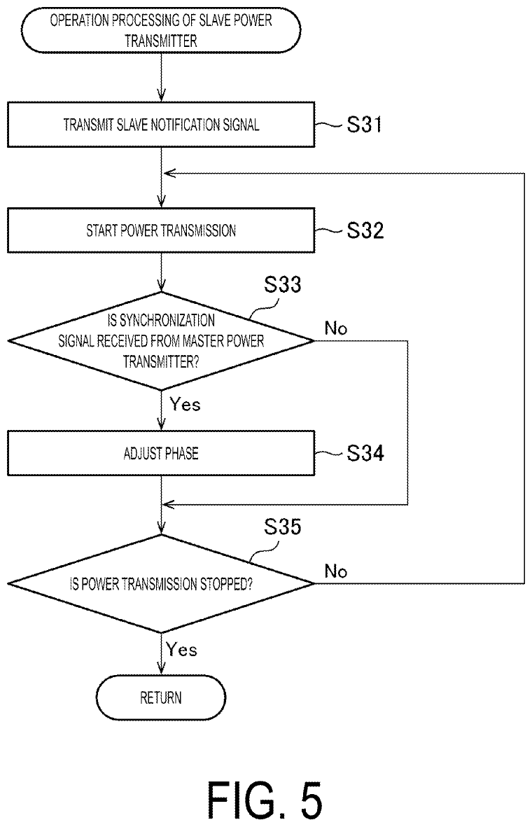

Next, operation processing of the slave power transmitter will be described with reference to FIG. 5. FIG. 5 is a flowchart illustrating an example of operation processing of the slave power transmitter according to the embodiment of the present disclosure.

First, the slave power transmitter transmits a slave notification signal indicating that the power transmitter itself is a slave power transmitter to the master power transmitter (step S31).

Next, the slave power transmitter starts power transmission to the power receiver 2 (step S32). At this time, in a case that a microwave is transmitted from the slave power transmitter to the power receiver 2 with a phase different from that of the master power transmitter, the power supply efficiency in the power receiver 2 is reduced. Thus, in the slave power transmitter, the power transmitter controller 15 determines whether a synchronization signal has been received from the master power transmitter (step S33). Here, in the slave power transmitter, in a case that the power transmitter controller 15 determines that the synchronization signal has been received (“YES” in step S33), the phase adjustment unit 52 adjusts the phase of the microwave to be transmitted to the power receiver 2 based on the received synchronization signal (step S34). Then, the slave power transmitter transmits the microwave with the adjusted phase to the power receiver 2.

During power supply to the power receiver 2, the power transmitter controller 15 determines whether to stop power transmission to the power receiver 2 (step S35). Specifically, in a case that a signal providing instruction to stop power transmission to the power receiver 2 has been received from the master power transmitter, the power transmitter controller 15 determines to stop power transmission to the power receiver 2.

Also, in a case of “NO” in step S33, it is determined that communication between the slave power transmitter and the master power transmitter is cut off, and the processing proceeds to step S35, where the slave power transmitter stops the power transmission to the power receiver 2.

In a case that it is determined to be “NO” in step S35, that is, in a case that the power transmission to the power receiver 2 is not stopped, the slave power transmitter returns to step S32 and repeats processing after step S32.

### Operation Processing of Power Receiver

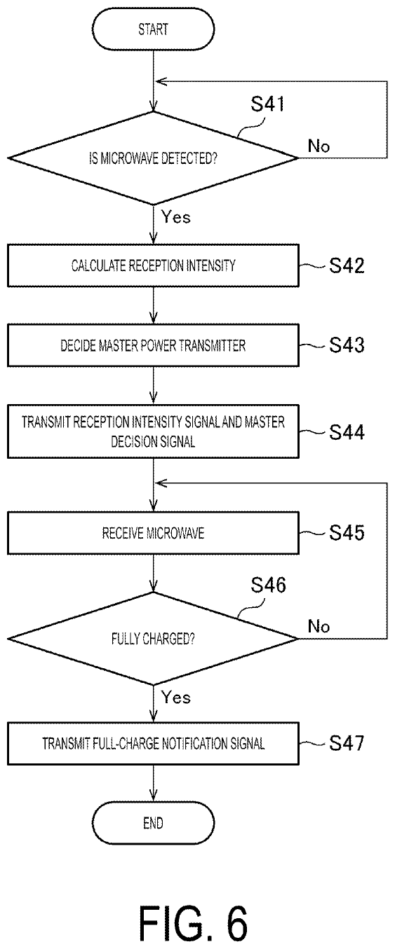

Now, operation processing of the power receiver 2 will be described with reference to FIG. 6. FIG. 6 is a flowchart illustrating an example of operation processing of the power receiver 2 according to the embodiment of the present disclosure.

First, in a case that the power receiver 2 moves into the power supply area 30, the power receiver controller 25 determines whether reception of a microwave radiated from each of the power transmitters 1a to 1f is detected (step S41). The power receiver 2 repeats the processing of step S41 until reception of a microwave is detected.

On the other hand, in a case that the power receiver controller 25 determines that reception of a microwave has been detected (“YES” in step S41), the reception level calculation unit 60 calculates a reception intensity of the microwave (step S42). Here, the reception level calculation unit 60 calculates a reception intensity of the microwave received from each of the power transmitters 1a to 1f within a predetermined period. Then, the master decision unit 62 decides the power transmitter 1 serving as the transmission source of the microwave having the highest reception intensity to be the master power transmitter (step S43).

Then, the power receiver 2 transmits, to each of the power transmitters 1a to 1f, a reception intensity signal indicating the reception intensity calculated by the reception level calculation unit 60 and a master decision signal indicating the identification number of the power transmitter 1a decided to be the master power transmitter by the master decision unit 62 (step S44). Thereafter, the power receiver 2 receives the microwave from each of the power transmitters 1a to 1f (step S45).

In a power supply period in which the power receiver 2 receives the microwave from each of the power transmitters 1a to 1f and supplies power, the reception level calculation unit 60 calculates the reception intensity of the microwave transmitted from each of the power transmitters 1a to 1f. Then, the power receiver 2 is configured to transmit a reception intensity signal indicating the calculated reception intensity to each of the power transmitters 1a to 1f. However, the present disclosure is not limited to this configuration. For example, in the power supply period, the power receiver 2 may be configured to calculate at least the reception intensity of the microwave transmitted from the master power transmitter and transmit the reception intensity signal only to the master power transmitter.

Next, in the power receiver 2, the power calculation unit 61 calculates an amount of power obtained by receiving the microwave transmitted from each of the power transmitters 1a to 1f. Then, the power calculation unit 61 determines whether a rechargeable battery has been fully charged based on the calculated amount of power (step S46). In a case that the power calculation unit 61 determines that the rechargeable battery has been fully charged (“YES” in step S46), the power receiver 2 transmits a full-charge notification signal to the master power transmitter (power transmitter 1a). On the other hand, in a case that the power calculation unit 61 determines that the rechargeable battery has not been fully charged (“NO” in step $46), the processing returns to step S45, and the power receiver 2 receives the microwave from each of the power transmitters 1a to 1f to continue power supply.

The power receiver 2 may return to step S41 described above and decide a new master power transmitter in a case that communication with the master power transmitter is cut off in the power supply period or in a case that the amount of power obtained from the microwave received from each of the power transmitters 1a to 1f becomes lower than a predetermined amount of power.

As described above, in the wireless power supply system 100 according to the embodiment, the power receiver 2 includes the master decision unit 62, and thus the power receiver 2 can decide an appropriate power transmitter 1 to be the master power transmitter of the plurality of power transmitters 1a to 1f with which the power receiver 2 can communicate.

The power transmitter 1 includes the master determination unit 51, and thus it is possible to determine whether the power transmitter 1 itself is the master power transmitter based on the signal received from the power receiver 2. Thus, even in a case that the power transmitter 1 configured as the master power transmitter cannot detect the power receiver 2 and cannot transmit a microwave, it is possible to switch to the power transmitter 1 capable of transmitting a microwave to the power receiver 2 to be the master power transmitter. Accordingly, the wireless power supply system 100 can appropriately supply power to the power receiver 2.

### Modification of Embodiment

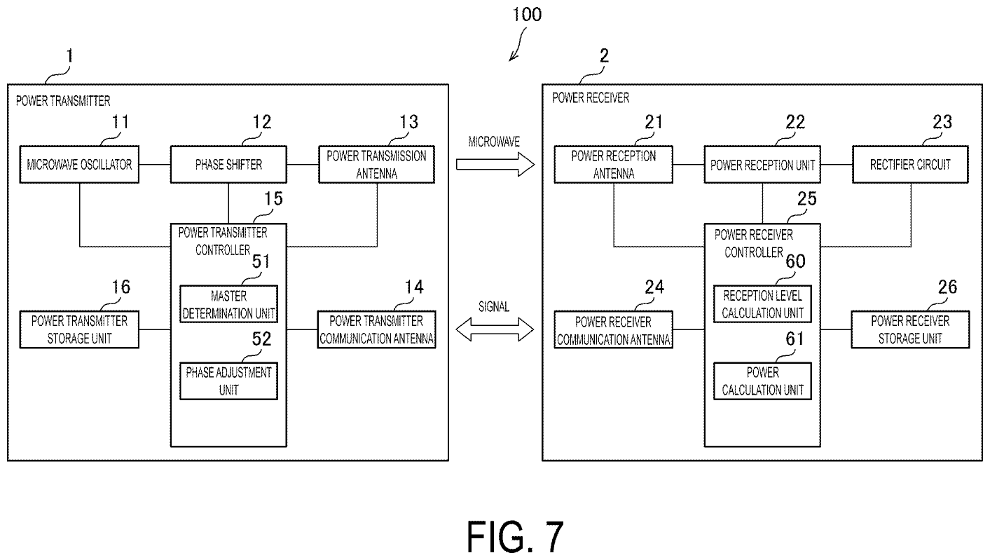

Next, a wireless power supply system 100 according to a modification of the embodiment of the present disclosure will be described with reference to FIG. 7. FIG. 7 is a block diagram illustrating a schematic configuration of the wireless power supply system 100 according to the modification of the embodiment of the present disclosure. As illustrated in FIG. 7, the wireless power supply system 100 according to the modification of the embodiment is different from the wireless power supply system 100 according to the embodiment in that the power receiver controller 25 does not include the master decision unit 62. Thus, in the wireless power supply system 100 according to the modification of the embodiment, the circuit configuration of the power receiver 2 can be made simpler than that of the power receiver 2 included in the wireless power supply system 100 according to the embodiment.

Another difference is that the master determination unit 51 in the power transmitter 1 can determine a power transmitter serving as the master power transmitter from among the other power transmitters.

As to the other points, the wireless power supply system 100 according to the modification of the embodiment is the same as the wireless power supply system 100 according to the embodiment. For this reason, the same members are denoted by the same reference numerals and the description thereof will be omitted.

That is, in the wireless power supply system 100 according to the embodiment, the power receiver 2 is configured to determine the master power transmitter, whereas in the wireless power supply system 100 according to the modification of the embodiment, the power transmitter 1 is configured to determine the power transmitter serving as the master power transmitter from among the other power transmitters.

Hereinafter, a power supply method in the wireless power supply system 100 according to the modification of the embodiment will be described.

### Power Supply Method

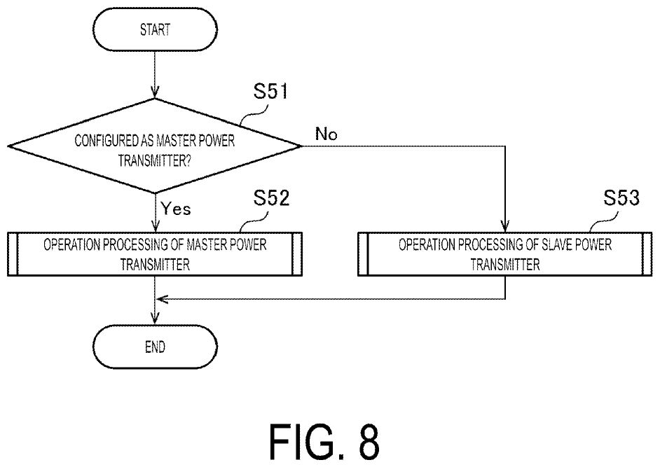

Now, a power supply method by the wireless power supply system 100 according to the modification of the embodiment will be described with reference to FIG. 8. FIG. 8 is a flowchart illustrating an example of a power supply operation of the power transmitter 1 in the wireless power supply system 100 according to the modification of the embodiment of the present disclosure.

First, as a premise, in the wireless power supply system 100 according to the modification of the embodiment, one of the power transmitters 1a to 1f is configured in advance as the master power transmitter. Here, for convenience of description, it is assumed that the power transmitter 1a is configured as the master power transmitter, and each of the power transmitters 1b to 1f is configured as a slave power transmitter, in advance. The slave power transmitter is configured to transmit, to the master power transmitter, a slave notification signal (notification signal) including information on the power receiver 2 as a transmission destination of a microwave and a reception intensity signal indicating a reception intensity of the microwave in the power receiver 2.

As illustrated in FIG. 8, the power transmitter 1 determines whether the power transmitter 1 itself is configured in advance as the master power transmitter (step S51). In a case of “YES” in step S51, the power transmitter 1 performs operation processing of the master power transmitter. On the other hand, in a case of “NO” in step S51, the power transmitter 1 performs operation processing of the slave power transmitter.

### Operation Processing of Master Power Transmitter

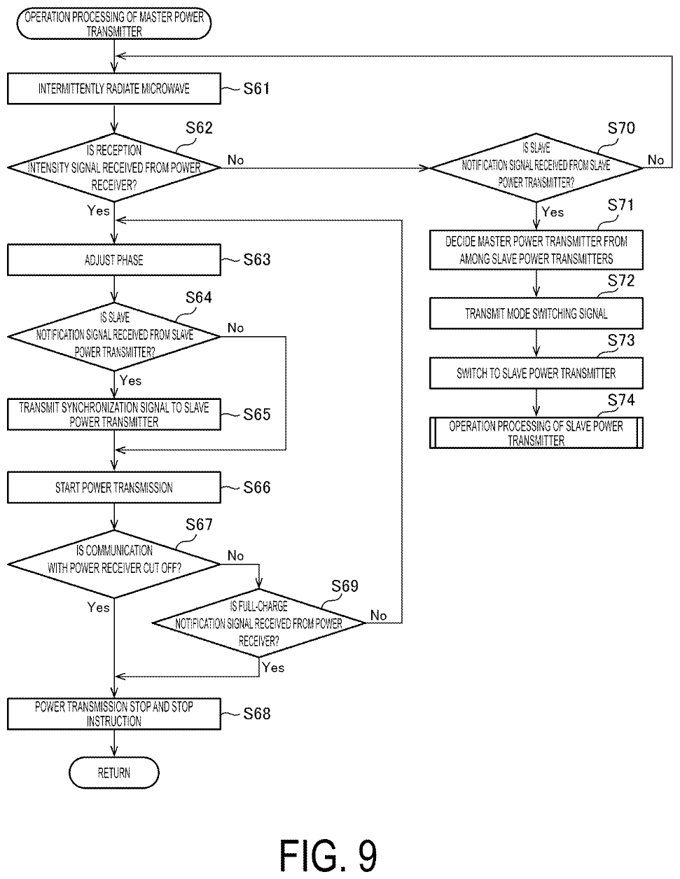

Now, operation processing of the master power transmitter will be described with reference to FIG. 9. FIG. 9 is a flowchart illustrating an example of operation processing of the master power transmitter according to the modification of the embodiment of the present disclosure.

As illustrated in FIG. 9, the master power transmitter (power transmitter 1a) intermittently radiates a microwave (step S51).

Here, in a case that the power receiver 2 receives the microwave radiated from the master power transmitter, the power receiver 2 transmits a reception intensity signal indicating a reception intensity of the received microwave to the master power transmitter. Thus, the master power transmitter can recognize the establishment of communication with the power receiver 2 and the reception intensity of the microwave in the power receiver 2 by receiving the reception intensity signal transmitted from the power receiver 2 via the power transmitter communication antenna 14.

In the master power transmitter, after radiating the microwave, the power transmitter controller 15 determines whether the reception intensity signal has been received from the power receiver 2 (step S62). In a case that the power transmitter controller 15 determines that the reception intensity signal has been received from the power receiver 2 (“YES” in step S62), the phase adjustment unit 52 adjusts the phase of the microwave based on this signal in such a manner that the reception intensity of the microwave is maximized in the power receiver 2 (step S63).

Next, in the master power transmitter, the power transmitter controller 15 determines whether a slave notification signal has been received from each of the slave power transmitters (power transmitters 1b to 1f) (step S64).

In a case that it is determined that the slave notification signal has been received from each of the slave power transmitters (“YES” in step S64), the power transmitter controller 15 transmits a synchronization signal to each of the slave power transmitters to perform synchronization with the phase of the microwave transmitted from the master power transmitter to the power receiver 2 (step S65). Then, the master power transmitter continuously transmits a microwave to the power receiver 2 to start power transmission (step S66).

The processing of subsequent step S67 to step S69 is the same as the processing of step S26 to step S28 illustrated in FIG. 4, and thus description thereof will be omitted. In a case of “NO” in step S69, that is, in a case that the power transmitter controller 15 determines that the signal indicating full charge has not been received from the power receiver 2, the processing returns to step S63, and the master power transmitter repeats adjustment of the phase of the microwave to be transmitted to the power receiver 2 again. Accordingly, even in a case that the power receiver 2 moves in the power supply area 30 and the distance to each of the power transmitters 1a to 1f changes, it is possible to adjust the phase of the microwave in such a manner that the reception intensity of the microwave received by the power receiver 2 increases.

On the other hand, in the master power transmitter, in a case that the power transmitter controller 15 determines that the signal indicating the reception intensity of the microwave has not been received from the power receiver 2 (“NO” in step S62), it is determined that communication between the master power transmitter and the power receiver 2 is cut off and the power transmitter is in a state in which the microwave cannot be transmitted to the power receiver 2. Thus, in a case of “NO” in step S62, the power transmitter controller 15 determines whether the slave notification signal has been received from each of the slave power transmitters (step S70). Here, in a case that the power transmitter controller 15 determines that the slave notification signal has not been received from each of the slave power transmitters (“NO” in step S70), the power transmitter controller 15 determines that the master power transmitter is also in a state in which communication with each of the slave power transmitters is cut off, the processing returns to the first step S61, and the operation processing is performed again.

On the other hand, in the master power transmitter (power transmitter 1a), in a case that the power transmitter controller 15 determines that the slave notification signal has been received from each of the slave power transmitters (“YES” in step S70), the master determination unit 51 determines a power transmitter serving as the master power transmitter from among the plurality of slave power transmitters (power transmitters 1b to 1f) (step S71). Specifically, based on the slave notification signal received from each of the slave power transmitters, the master determination unit 51 determines, to be the master power transmitter, a power transmitter having the highest reception intensity of the microwave in the power receiver 2 of the slave power transmitters.

In a case that the master determination unit 51 determines the power transmitter serving as the master power transmitter, the master power transmitter transmits an operation mode switching signal for providing instruction on operation switching to the master power transmitter to the power transmitter determined to be the master power transmitter (step S72). The power transmitter that has received the operation mode switching signal performs the operation processing of the master power transmitter illustrated in FIG. 9 described above as the master power transmitter.

Next, the power transmitter controller 15 switches the configured operation mode from the master power transmitter to the slave power transmitter (step S73). Then, operation processing of the slave power transmitter is performed (step S74).

### Operation Processing of Slave Power Transmitter

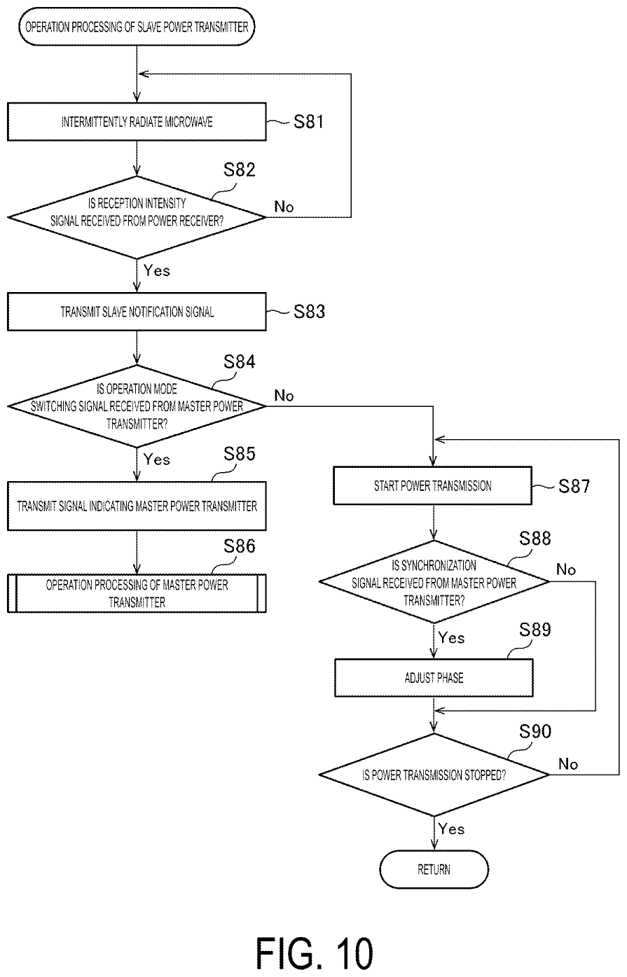

Now, operation processing of the slave power transmitter illustrated in step S53 of FIG. 8 or step S74 of FIG. 9 will be described in detail with reference to FIG. 10. FIG. 10 is a flowchart illustrating an example of the operation processing of the slave power transmitter according to the modification of the embodiment of the present disclosure.

The slave power transmitter intermittently radiates a microwave (step S81). In a case that the power receiver 2 receives the microwave radiated from the slave power transmitter, the power receiver 2 transmits the reception intensity signal indicating the reception intensity of the received microwave to the slave power transmitter. Thus, the slave power transmitter can recognize the establishment of communication with the power receiver 2 and the reception intensity of the microwave in the power receiver 2 by receiving the reception intensity signal transmitted from the power receiver 2.

In the slave power transmitter, after the microwave is radiated, the power transmitter controller 15 determines whether the reception intensity signal has been received from the power receiver 2 (step S82). In a case that it is determined that the reception intensity signal has been received from the power receiver 2 (“YES” in step S82), the power transmitter controller 15 transmits the slave notification signal indicating that the power transmitter is a slave power transmitter to the master power transmitter (step S83).

Next, in the slave power transmitter, the power transmitter controller 15 determines whether the operation mode switching signal has been received from the master power transmitter (step S84). Here, in a case that the power transmitter controller 15 determines that the operation mode switching signal has been received (“YES” in step S84), the slave power transmitter transmits a signal indicating that the power transmitter is the master power transmitter to the other power transmitters provided in the power supply area 30 (step S85), and performs operation processing as the master power transmitter (step S86).

On the other hand, in a case that the power transmitter controller 15 determines that the operation mode switching signal has not been received (“NO” in step S84), the slave power transmitter starts power transmission to the power receiver 2 (step S87). In the slave power transmitter, in a case that the power transmitter controller 15 determines that a synchronization signal has been received from the master power transmitter (“YES” in step S88), the phase adjustment unit 52 controls the phase shifter 12 based on the synchronization signal to adjust the phase of the microwave to be transmitted to the power receiver 2 (step S89). Then, the slave power transmitter transmits the microwave with the adjusted phase to the power receiver 2.

On the other hand, in a case that the power transmitter controller 15 determines that the synchronization signal has not been received from the master power transmitter (“NO” in step S88), transmission of the microwave to the power receiver 2 is continued without adjusting the phase.

In the slave power transmitter, in a case that the power transmitter controller 15 determines that a signal indicating stop of power transmission has been received from the master power transmitter (“YES” in step S90), power transmission to the power receiver 2 is stopped. On the other hand, while the power transmitter controller 15 determines that the signal indicating the stop of power transmission has not been received from the master power transmitter (“NO” in step S90), the processing returns to step S87 and power transmission to the power receiver 2 is continued.

### Operation Processing of Power Receiver

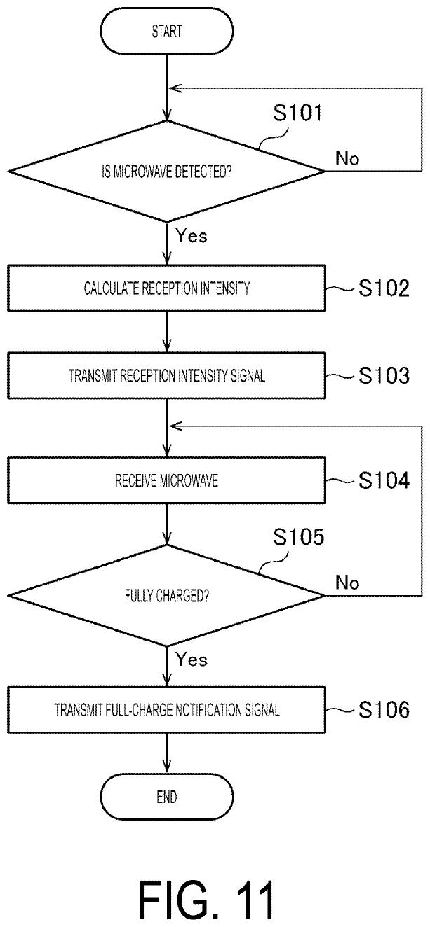

Now, operation processing of the power receiver 2 will be described with reference to FIG. 11. FIG. 11 is a flowchart illustrating an example of operation processing of the power receiver 2 according to the modification of the embodiment of the present disclosure.

First, in a case that the power receiver 2 moves into the power supply area 30, the power receiver controller 25 determines whether reception of the microwave radiated from each of the power transmitters 1a to 1f is detected (step S101). The power receiver 2 repeats the processing of step S101 until reception of the microwave is detected.

On the other hand, in a case that the power receiver controller 25 determines that reception of the microwave is detected (“YES” in step S101), the reception level calculation unit 60 calculates the reception intensity of the microwave received from each of the power transmitters 1a to 1f (step S102).

Then, the power receiver 2 transmits a reception intensity signal indicating the reception intensity calculated by the reception level calculation unit 60 to each of the power transmitters 1a to 1f (step S103). The processing of subsequent steps S104 to S106 is the same as the processing of steps S45 to S47 illustrated in FIG. 6, and thus the description thereof will be omitted.

As described above, in the wireless power supply system 100 according to the modification of the embodiment, the power transmitter (power transmitter 1a) includes the master determination unit 51, and thus, in a case that communication with the power receiver 2 cannot be established, a master power transmitter can be decided from among the other power transmitters (power transmitters 1b to 1f) based on the slave notification signals received from the other power transmitters. Thus, even in a case that the power transmitter 1 configured as the master power transmitter cannot detect the power receiver 2 and cannot transmit a microwave, it is possible to switch to the power transmitter 1 capable of transmitting a microwave to the power receiver 2 to be the master power transmitter. Accordingly, the wireless power supply system 100 can appropriately supply power to the power receiver 2.

1. A wireless power supply system, comprising:
a plurality of power transmitters including a master power transmitter and slave power transmitters controlled by the master power transmitter; and
a power receiver to which power is supplied by a radio wave transmitted from each of the plurality of power transmitters, wherein
a first power transmitter of the plurality of power transmitters includes a determination unit configured to determine a power transmitter serving as the master power transmitter based on a signal received from the power receiver or each of other power transmitters of the plurality of power transmitters.

2. The wireless power supply system according to claim 1, wherein
the power receiver includes a decision unit configured to decide, to be the master power transmitter, a power transmitter serving as a transmission source of a radio wave having a highest intensity among a plurality of the radio waves received from the plurality of power transmitters and
a power receiver-side signal transmitter configured to transmit a master decision signal including information on the master power transmitter decided by the decision unit, to each of the plurality of power transmitters, and
the first power transmitter causes the determination unit to determine whether the first power transmitter is the master power transmitter, based on the master decision signal received from the power receiver.

3. The wireless power supply system according to claim 1, wherein
each of the plurality of power transmitters receives, from the power receiver, a reception intensity signal indicating a reception intensity of the radio wave transmitted to the power receiver,
the first power transmitter includes a power transmitter-side signal receiver configured to receive a notification signal including information on the reception intensity from each of the other power transmitters, and
the first power transmitter causes the determination unit to determine, based on the notification signal received by the power transmitter-side signal receiver, a power transmitter having a highest reception intensity of a radio wave among the other power transmitters to be the master power transmitter.

4. The wireless power supply system according to claim 1, wherein the master power transmitter includes a phase adjustment unit configured to adjust a phase of the radio wave to be transmitted to the power receiver.

5. The wireless power supply system according to claim 4, wherein the master power transmitter includes a power transmitter-side signal transmitter configured to transmit, to the slave power transmitters, a synchronization signal to synchronize the phase of the radio wave to be transmitted to the power receiver with a phase of a radio wave adjusted by the phase adjustment unit.

6. The wireless power supply system according to claim 4, wherein the master power transmitter repeatedly adjusts the phase of the radio wave to be transmitted to the power receiver while power is being supplied to the power receiver by the radio waves transmitted from the plurality of power transmitters.

7. A power transmitter included in a wireless power supply system in which power is supplied to a power receiver by radio waves transmitted from a plurality of power transmitters including a master power transmitter and slave power transmitters controlled by the master power transmitter, the power transmitter comprising
a determination unit configured to determine a power transmitter serving as the master power transmitter based on a signal received from the power receiver or other power transmitters of the plurality of power transmitters.

8. The power transmitter according to claim 7, wherein
each of the plurality of power transmitters receives, from the power receiver, a reception intensity signal indicating a reception intensity of the radio wave transmitted to the power receiver,
the power transmitter includes a power transmitter-side signal receiver configured to receive a notification signal including information on the reception intensity from each of the other power transmitters of the plurality of power transmitters, and
based on the notification signal received by the power transmitter-side signal receiver, the determination unit determines, to be the master power transmitter, a power transmitter having a highest reception intensity of a radio wave among the other power transmitters.

9. A power receiver included in a wireless power supply system in which power is supplied to the power receiver by radio waves transmitted from a plurality of power transmitters including a master power transmitter and slave power transmitters controlled by the master power transmitter, the power receiver comprising:
a decision unit configured to decide, to be the master power transmitter, a power transmitter serving as a transmission source of a radio wave having a highest intensity among radio waves received from the plurality of power transmitters; and
a power receiver-side signal transmitter configured to transmit a master decision signal including information on the master power transmitter decided by the decision unit, to each of the plurality of power transmitters.

10. (canceled)
